(19) United States
(12) Patent Application Publication
(10) Pub. No.: US 2007/0050619 A1
(43) Pub. Date: Mar. 1, 2007

(54) Processor having program protection function

(75) Inventors: Takashi Miyamori, Kanagawa (JP); Mikio Hashimoto, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/353,178

(22) Filed: Feb. 14, 2006

(30) Foreign Application Priority Data
Aug. 24, 2005 (JP) P2005-243244

(51) Int. Cl. H04L 9/00

(52) U.S. Cl. 713/164

(57) ABSTRACT

A processor having a program protection function, which makes behavior analysis of protected programs difficult and allows improvement in the current program protection level, which is attained by prohibiting reading out/rewriting of instruction codes, is provided. The processor having a program protection function is a processor core module, which protects programs by allowing only reading out of instructions in a decrypted, protected plain text program for being executed and which is constituted by a detecting unit for detecting whether or not an instruction in a protected program is being executed and a prohibiting unit for prohibiting generation of trace information for an instruction being executed when the detecting unit detects that an instruction in a protected program is being executed.

### CROSS REFERENCE TO RELATED APPLICATIONS AND INCORPORATION BY REFERENCE

This application is based upon and claims the benefit of priority from prior Japanese Patent Application P2005-243244 filed on Aug. 24, 2005; the entire contents of which are incorporated by reference herein.

### BACKGROUND OF THE INVENTION

1. Field of the Invention

The present invention relates to security technology for a microprocessor including a processor core. More specifically, it relates to a processor having a program protection function, which makes behavior analysis of protection programs difficult.

2. Description of the Related Art

In recent years, a debugging function has been embedded in microprocessors so as to improve program development efficiency during system development. In addition, since an increase in processor operating speed makes it difficult to externally monitor signals, a technology to support program development on an actual system apparatus, by embedding a program/data trace function in a processor has been developed.

A technology for protection user developed programs and preventing such programs from being illegally monitored or tampered with has been provided by encrypting those programs before storing them in an external memory of a processor and decrypting and executing the encrypted programs before reading them out to protected memory in the processor (see, e.g., Japanese Patent Application Laid-Open No. 2004-280678).

Furthermore, when protection data transferred among multiple systems, data protection methods for respective systems need to be the same. While encryption programs used for such data protection along with necessary information for users to develop systems are provided for them, it is desirable that contents thereof not be disclosed even to the system developers so as to assure security of the programs. With such system development, there is a mixture of programs required to be protected without disclosure of contents thereof and unprotected programs or a developing target for developers. A processor technology capable of appropriate program protection under such circumstances has been developed.

However, even if program codes are protected from being accessed for illegal copy, a processor having a traceable debugging function can obtain a program execution order, data access information or the like from trace results, and also obtain information of change in register value by running the processor in a single step mode using a debug exception. Analyzing such information is not so easy; however, such information may provide a possibility of analysis of, for example, programmed processing (algorithm).

### SUMMARY OF THE INVENTION

An aspect of the present invention inheres in a processor having a program protection function, which protects a program by allowing only reading out of an instruction of a decrypted, protected plain text program for being executed. The processor includes a protected program instruction execution detecting unit configured to detect whether or not an instruction in a protected program is being executed; and a trace information generating unit configured to prohibit generation of trace information for an instruction being executed when detecting that an instruction in a protected program is being executed.

Another aspect of the present invention inheres in a a processor having a program protection function, which protects a program by allowing reading out of only an instruction in a protected program decrypted to plain text for being executed by the instruction. The processor includes a protected program instruction execution detecting unit configured to detect whether or not an instruction in a protected program is being executed; and a debug exception occurrence prohibiting unit configured to prohibit occurrence of a debug exception when the protected program instruction execution detecting unit detects that an instruction in a protected program is being executed.

Another aspect of the present invention inheres in a processor having a program protection function, which protects a program by allowing reading out of only an instruction in a protected program decrypted to plain text for execution and executing an instruction read out from program memory. The processor includes a protection bit signal storage unit configured to store a protection bit which indicates whether or not a part of the program memory is being protected; a program counter configured to designate an instruction execution address; and a trace information generating unit configured to read out an instruction from an address of the program memory designated by the program counter, and detect whether or not the corresponding region is being protected, and if yes, output a code, which indicates that no instructions are executed as trace information, and prohibit generation of trace information of an instruction being executed.

### BRIEF DESCRIPTION OF THE DRAWINGS

FIG. 1 schematically shows a block diagram of a processor having an instruction memory protection function and a traceable debugging function;

FIG. 2 schematically shows a block diagram of a processor core module having a program protection function;

FIG. 3 schematically shows a block diagram of a protected information controller in a trace information generating unit;

FIG. 4 schematically shows a block diagram of a fetch address generating unit in an instruction fetch unit; and

FIG. 5 is a table showing various trace mode signals.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Referring to the drawings, embodiments of the present invention are described below. The embodiments shown below exemplify an apparatus and a method that are used to implement the technical ideas according to the present invention, and do not limit the technical ideas according to the present invention to those that appear below. These technical ideas, according to the present invention, may receive a variety of modifications that fall within the claims.

According to a processor having a program protection function of the present embodiments, behavior analysis of protected programs is made difficult by prohibiting execution of an instruction to read/write from/to a region in a memory in which a decrypted plain text program to be protected is loaded and providing a microprocessor, which protects programs, with a control ability so as to prevent trace information from being output during execution of a protected program and also prohibit occurrence of a debug exception. This improves the current program protection level, which has been attained by prohibiting instruction codes from being read out and written in.

### First Embodiment

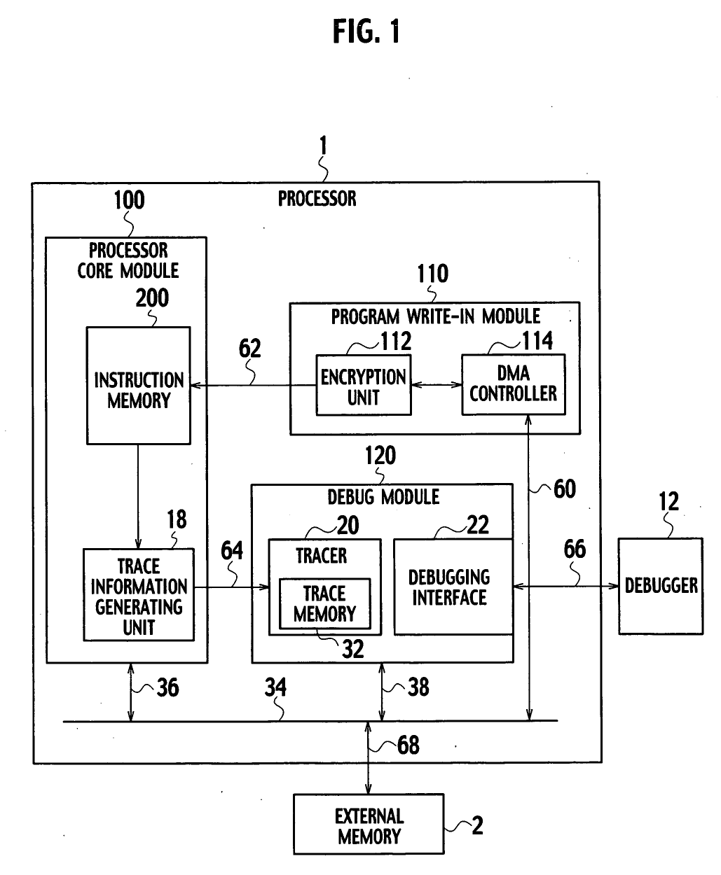

A processor having a program protection function according to the first embodiment of the present invention is described using FIGS. 1 through 5. Signal lines of block diagrams of FIGS. 1 through 4 represent main data or control signals used for describing the processor having a program protection function.

Note that in the following description, the processor having a program protection function according to the first embodiment of the present invention is referred to as a processor core module 100 to prevent confusion from a processor 1 constituted by connecting more than one processor and memory via internal buses.

The processor having a program protection function according to the first embodiment of the present invention, which protects programs by allowing only reading out of instructions for execution in a protected program decrypted to plain text, is constituted by a detecting unit, which detects whether or not an instruction in a protected program is being executed, and a prohibiting unit, which prohibits generation of trace information for an instruction being executed when the detecting unit detects that an instruction in a protected program is being executed.

In addition, according to the processor having a program protection function, the prohibiting unit generates trace information which indicates that no instructions are executed instead of trace information of an actually executed instruction when the detecting unit detects that an instruction in a protected program is being executed.

The processor with the program protection function further includes a trace information generating unit, which generates a code indicating execution of a branch instruction and trace information including a branch destination address when a branch instruction is being executed, a branch condition is satisfied, and a branch destination address is outside the area to be protected during execution of a protected program.

Moreover, according to the processor with a program protection function, a branch destination address to be output during execution of a protected program may represent the entirety of address information.

Furthermore, the processor with a program protection function, which protects programs by allowing only reading out of instructions for executing the instructions in a protected program decrypted to plain text, is constituted by a detecting unit, which detects whether or not an instruction in a protected program is being executed, and a prohibiting unit, which prohibits occurrence of a debug exception when the detecting unit detects that an instruction in a protected program is being executed.

The detecting unit, which detects whether or not an instruction in a protected program is being executed, includes protection bits indicating whether or not loaded protected plain text programs in respective regions of program memory constituted by one region or more than one region are being protected and, reads out an instruction from an address of the program memory designated by a program counter, reads out a protection bit from a region including the address designated by the program counter, and then detects whether or not an instruction in a protected program is being executed.

The processor having a program protection function maintaining development efficiency of a user program (unprotected program) being developed by generating and displaying trace information to facilitate debugging on an actual system device. Generation of trace information indicating execution logs of a protected program is prohibited so as to prevent the protected program from being subjected to algorithm analysis using information such as program loop statuses and loop counts, thereby improving the protection level.

The processor having a program protection function minimizes the amount of trace information and provides a trace information generating system configured to output instruction types and branch destination addresses without instruction execution addresses so as to compress trace information. When such system operates based on a mixture of an unprotected program and a protected program, a branch address for branching from the protected program to the unprotected program may be obtained. This increases reliability of trace information analysis of the unprotected program.

The processor with a program protection function maintains development efficiency of a user program (unprotected program) being developed by generating a debug exception for displaying various types of processor information at a specified time to facilitate debugging, and a debug exception is prohibited for a protected program so as to prevent disclosure of changes in processor register values for every single step operation. This prevents disclosure of instruction types in the protected program and improves protection level.

(Structure of Processor)

FIG. 1 schematically shows a block diagram of a processor having an instruction memory protection function and a traceable debugging function, a block diagram of a processor 1 constituted by a debug module 120 used for debugging and loading programs to be protected, a protected program write-in module 110, and a processor core module 100.

As shown in FIG. 1, the processor 1 is constituted by the processor core module 100 including instruction memory 200, an execution unit 400, and a trace information generating unit 300. The debug module 120 includes a tracer 20 embedded with trace memory 32 and a debugging interface 22. The protected program write-in module 110 includes an encryption unit 112 and a DMA controller 114. A main bus 34 is used to connect the processor core module 100, the debug module 120, and the protected program write-in module 110 via buses 36, 38, and 60. A read/write (R/W) bus 62 is used to connect the processor core module 100 and the protected program write-in module 110, a trace information bus 64 connects the processor core module 100 and the debug module 120, a debug output bus 66 connects a debugger 12 provided outside the processor 1 and the debug module 120, and an external bus 68 is used to connect external memory 2 provided outside the processor 1 and the main bus 34.

The processor core module 100 reads and executes processor instructions. The debug module 120 is provided with the debugging interface 22 connected to the external debugger 12 via the debug output bus 66, and is controllable by the external debugger 12 while debugging.

The trace information generating unit 300 provided in the processor core module 100 is connected to the tracer 20 via the trace information bus 64, receives information indicating instruction execution status of the processor core module 100, and outputs trace information to the tracer 20 in the debug module 120.

As shown in FIG. 1, the tracer 20 includes the trace memory 32 which stores trace information indicating program execution status of the processor 1, and conducts trace analysis of the contents in the trace memory 32. During a trace operation, the trace information generating unit 300, in the processor core module 100, which has executed a program, outputs trace information such as instruction types, address information, data information, and operating status of the trace information generating unit 300 to the tracer 20.

After completion of the trace operation, the debugger 12 reads out the contents of the trace memory 32 from the tracer 20, analyzes a program being executed by the processor core module 100 using a trace analysis program, and outputs program execution status of the program being executed by processor core module 100.

As shown in FIG. 1, the processor core module 100 in the processor 1 having a program protection function is connected to the protected program write-in module 110 via the read/write (R/W) bus 62, and the instruction memory 200 stores programs. In addition, the processor core module 100 is connected to the debug module 120 via the trace information bus 64, and the trace information generating unit 300 outputs trace information.

The protected program write-in module 110 uses the DMA controller 114 to read out a program from the external memory 2 connected via the bus 60, the main bus 34, and the external bus 68, and then write the program in the instruction memory 200. A protected program in the external memory 2 is encrypted. The DMA controller 114 decrypts the program read out via the encryption unit 112, and writes the protected program converted to plain text and a protection information signal PISA in the instruction memory 200.

The debug module 120 receives trace information from the trace information generating unit 300 via the trace information bus 64, stores the trace information in the trace memory 32 of the tracer 20, and outputs the trace information to the debugger 12 provided outside the processor 1 via the debugging interface 22 and the debug output bus 66.

(Processor Core Module)

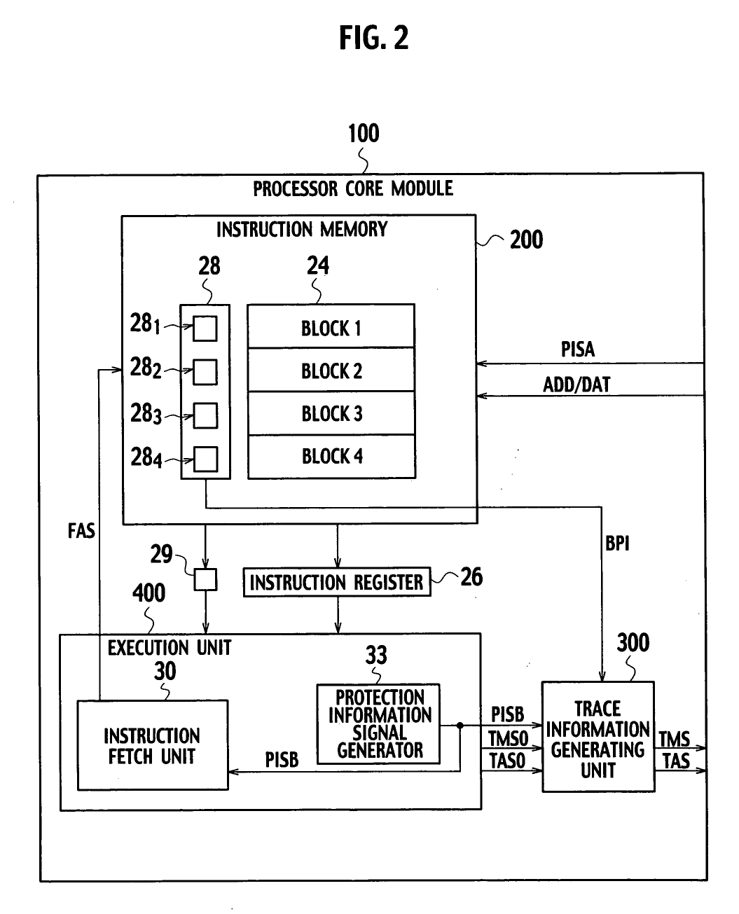

FIG. 2 schematically shows a block diagram of major components for protection programs in a processor core module 100.

As shown in FIG. 2, the processor core module 100 is constituted by instruction memory 200, which includes instruction RAM 24 and a protection bit signal storage unit 28 and stores program instruction codes to be executed, a trace information generating unit 300, which generates trace information indicating instruction execution status of the processor core module 100, and an execution unit 400, which includes a protection information signal generator 33 and an instruction fetch unit 30. The execution unit 400 decodes and executes instruction codes read out from the instruction memory 200, and reads out a subsequent instruction code to be executed.

The processor core module 100 receives a protection information signal PISA and address/data ADD/DAT from the protection program write-in module 110 via the bus 62 and stores the signal and the data in the instruction memory 200.

The instruction memory 200 is constituted by the instruction RAM 24 including four storage blocks (blocks 1 through 4), and the protection bit signal storage unit 28 including a block 1 protection bit signal storage area 28₁ for storing a block 1 protection bit, a block 2 protection bit signal storage area 28₂ for storing a block 2 protection bit, a block 3 protection bit signal storage area 28₃ for storing a block 3 protection bit, and a block 4 protection bit signal storage area 28₄ for storing a block 4 protection bit, which correspond to the respective storage areas (blocks 1 through 4).

A program (data) is written in the instruction RAM 24 output from the program write-in module 110, and at the same time, a protection information signal PISA value, indicating whether or not the program written in the instruction RAM 24 is the decrypted protection program, is written in the appropriate block (1 through 4) protection bit signal storage areas 28₁, through 28₄ corresponding to the storage area in the instruction RAM 24 to which the program is written.

In the case of the protected program, the protection information signal PISA is activated, and data ‘1’ is written in the corresponding block (1 through 4) protection bit signal storage area (28₁ through 28₄). An instruction code stored in a region of the instruction memory 200 specified by a fetch address FAS output from an instruction fetch unit 30 in the execution unit 400 and a corresponding block protection bit are read out, and output to an instruction register 26 and a protection bit signal storing register 29, respectively.

The execution unit 400 is connected to the instruction register 26 and the protection bit signal storing register 29. The execution unit 400 is constituted by a protection information signal generator 33, which receives block protection bits, and an instruction fetch unit 30, outputs a fetch address FAS to the instruction memory 200, and transmits a protection information signal PISB, a trace mode signal TMS0, and a trace address signal TAS0 to the trace information generating unit 300. The protection information signal PISB is also transmitted to the instruction fetch unit 30 from the protection information signal generator 33 in the execution unit 400.

More specifically, the execution unit 400 is a major component of the processor core for executing instruction codes read in the instruction register 26, and includes the protection information signal generator 33 which generates a protection information signal PISB using a block protection bit value read out at the same time as an instruction code when an instruction is executed. For example, when the executed instruction code is read out from the block 2 which is stored with a protected program, data ‘1’ written in the block 2 protection bit signal storage area 28₂ is read in the protection bit signal storing register 29, and data ‘1’ is generated as a protection information signal PISB.

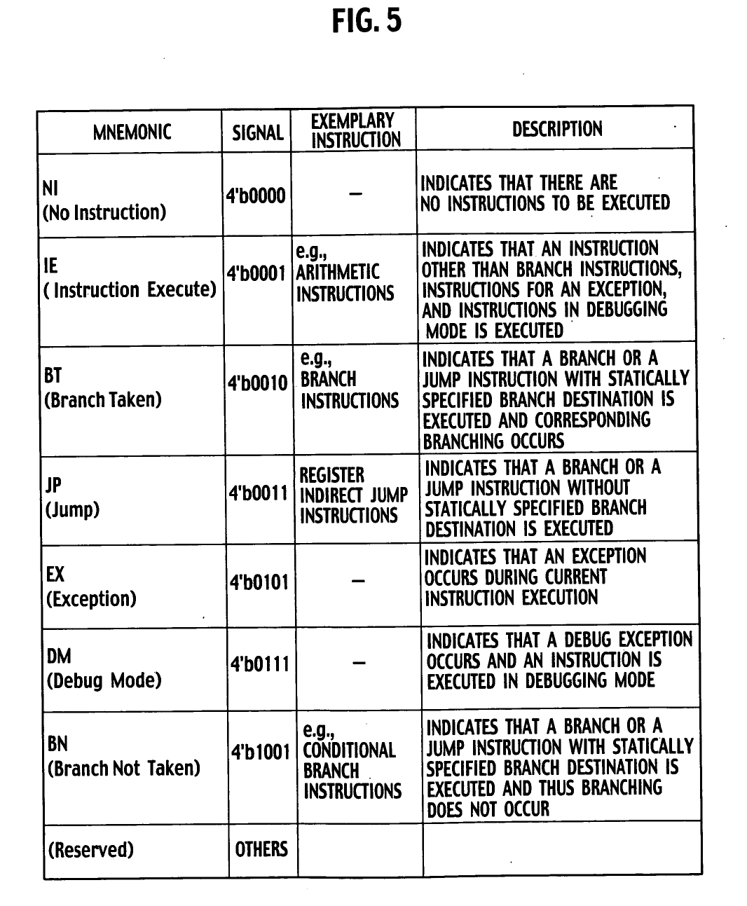

In addition, when an instruction is executed, the execution unit 400 outputs a protection information signal PISB and a trace mode signal TMS0 for the instruction to the trace information generating unit 300, shown in FIG. 5. When a branch or a jump instruction is executed, a trace address signal TAS0 is output to the trace information generating unit 300.

As shown in FIG. 5, the trace mode signals include: a code (NI=4′b0000) indicating that there are no instructions to be executed; a code (IE=4′b0001) indicating that an instruction other than branch instructions, instructions for an exception, and instructions in a debugging mode is executed; a code (BT=4′b0010) indicating that a branch or a jump instruction with a statically specified branch destination is executed and branching thus occurs; a code (JP=4′b0011) indicating that a branch or a jump instruction without a statically specified branch destination is executed; a code (EX=4′b0101) indicating that an exception occurs during current instruction execution; a code (DM=4′b0111) indicating that a debug exception occurs and an instruction is executed in the debugging mode; a code (BN=4′b1001) indicating that a branch or a jump instruction with a statically specified branch destination is executed but branching does not occur.

(Trace Information Generating Unit)

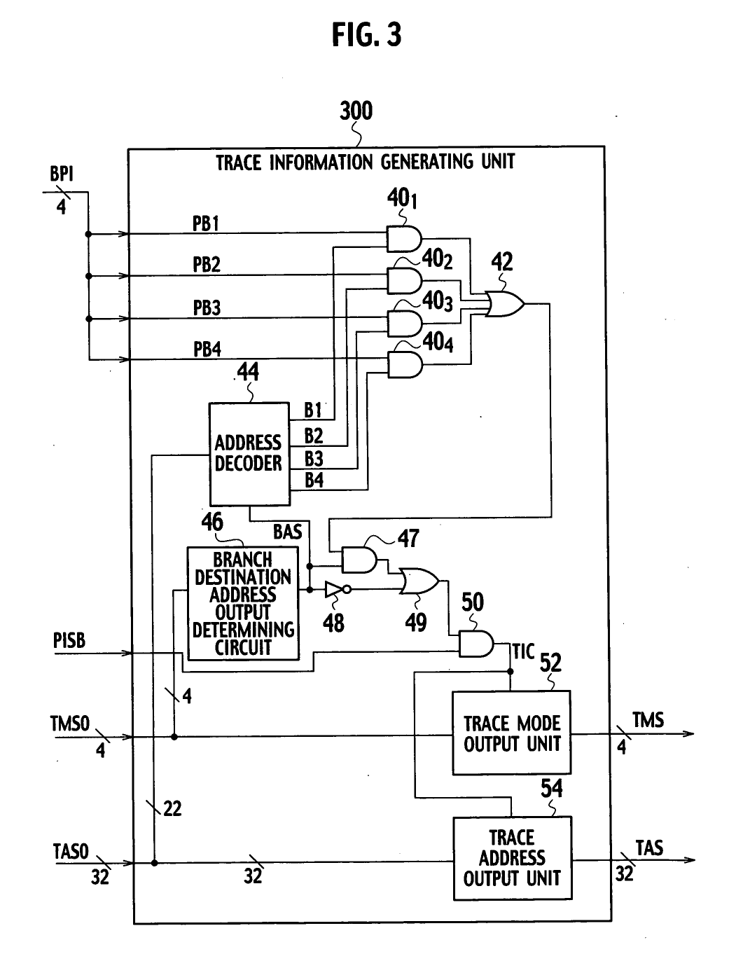

Next, handling of trace information output from a processor core module 100 when a protected instruction is executed is described while referencing FIG. 3. FIG. 3 schematically shows a block diagram of major components in a protection information controller of a trace information generating unit 300.

As shown in FIG. 3, the trace information generating unit 300 receives a trace mode signal TMS0 and a trace address signal TAS0 from an execution unit 400 in sync with a protection information signal PISB for the executed instruction output from the execution unit 400 and four elements of block protection information BPI from the instruction RAM 24, converts the executed instruction to a trace mode signal TMS and a trace address signal TAS, and then outputs the resulting converted signals to a tracer 20 in a debug module 120.

More specifically, as shown in FIG. 3, the trace information generating unit 300 is constituted by an address decoder 44 and a trace address output unit 54, which receive a trace address signal TAS0, a branch destination address output determining circuit 46 and a trace mode output unit 52, which receive a trace mode signal TMS0, AND gates 40₁, 40₂, 40₃, and 40₄, which receive a block 1 protection bit signal PB1, a block 2 protection bit signal PB2, a block 3 protection bit signal PB3, and a block 4 protection bit signal PB4 corresponding to respective output signals B1, B2, B3, and B4 from the address decoder 44 and respective four pieces of block protection information BPI from the instruction RAM 24, an OR gate 42, which receives output signals from the AND gates 40₁, 40₂, 40₃, and 40₄, an AND gate 47, which receives an output signal from the OR gate 42 and an output signal BAS from the branch destination address output determining circuit 46, an inverter 48, which inverts the output signal BAS from the branch destination address output determining circuit 46, an OR gate 49, which receives output signals from the AND gate 47 and the inverter 48, and an AND gate 50, which receives a protection information signal PISB and an output signal from the OR gate 49 and outputs a trace information output control signal TIC to the trace address output unit 54 and the trace mode output unit 52.

The output signal BAS from the branch destination address output determining circuit 46 is input not only to the AND gate 47 and the inverter 48, but also to the address decoder 44. Upon reception of the trace mode signal TMS0 the trace mode output unit 52 converts an executed instruction to a trace mode signal TMS. Upon reception of the trace address signal TAS0, the trace address output unit 54 converts an executed instruction to a trace address signal TAS.

As described above, trace information is output from the execution unit 400 to the outside of the processor core module 100 via the trace information generating unit 300.

In the trace information generating unit 300, when a protection information signal PISB is data ‘0’ and an executed instruction is not protected, the trace mode output unit 52 and the trace address output unit 54 are controlled to output a trace mode signal TMS0 and a trace address signal TAS0 as they are, which have been received from the execution unit 400, leaving the processor core module 100.

In the trace information generating unit 300, when a protection information signal PISB is data ‘1’ and an executed instruction is protected, the trace mode output unit 52 is controlled to output, as the trace mode signal TMS, a code (NI=4′b0000 in FIG. 5) indicating that no instructions are executed, instead of a trace mode signal TMS0 output from the execution unit 400, leaving the processor core module 100. In addition, the trace address output unit 54 is controlled so as not to output actual trace address information as the trace address signals TAS, and instead outputs all bits of 0.

Note that even in the case of the protection information signal PISB being data ‘1’, when the trace mode signal TMS0, output from the execution unit 400, is a code (BT=4′b0010, JP=4′b0011, EX=4′b0101 in FIG. 5) indicating a branch or a jump instruction, and the output signal BAS from the branch destination address output determining circuit 46 is active, it is determined whether or not the branch destination address designated by the trace address signal TAS0 output from the execution unit 400 is equal to an address in a protected block of the instruction RAM 24.

In the case of the branch destination address being equal to an address in a protected block of the instruction RAM 24, the trace mode output unit 52 is controlled to output, as the trace mode signal TMS, a code (NI=4′b0000 in FIG. 5) indicating that no instructions are executed, instead of the trace mode signal TMS0 output from the execution unit 400, leaving the processor core module 100. In addition, the trace address output unit 54 is controlled so as not to output as the trace address signals TAS actual trace address information, and instead outputs all bits of 0.

When the branch destination address is not included in a protected block of the instruction RAM 24, branching from a protected program to an unprotected program occurs. Therefore, the trace mode signal TMS0 and the trace address signal TAS0 output from the execution unit 400 are then output as they are to the tracer 20 in the debug module 120 via the trace information bus 64 from the trace information generating unit 300 in the processor core module 100. Trace information constituted by the trace mode signal TMS0 and the trace address signal TAS0 may be stored in the trace memory 32 of the tracer 20.

In the case where the processor core module 100 outputs the difference between the currently executed program counter value and the branch destination address when outputting branch destination address information as the trace address signal TAS, and so as not to output an upper address when the upper address of the former value is the same as that of the latter address, the processor core module 100 always outputs 32-bit address information since the protected program counter value is not output when branching to the unprotected area in conformity with the protected branch instruction.

Note that the size of the instruction memory 200 is 4 KB in FIG. 3. Therefore, 22 upper address bits are input to the address decoder 44, which determines whether or not a block in the instruction RAM 24 is protected. When the size of the instruction RAM 24 is 4 KB, and the start address is 0x0000_{—}0000, the address of block 1 ranges from 0x0000_{—}0000 to 0x0000_{—}03FF, the address of block 2 ranges from 0x0000_{—}0400 to 0x0000_{—}07FF, the address of block 3 ranges from 0x0000_{—}0800 to 0x0000_{—}08FF, and the address of block 4 ranges from 0x0000_{—}0C00 to 0x0000_{—}0FFFF. Twenty bits between the 31st and the twelfth bit of the address 0x0000_{—}00 indicates the instruction RAM 24, the eleventh and the tenth bit of the address generate a signal which indicates a block, allowing corresponding block protection bit value to be output.

(Instruction Fetch Unit)

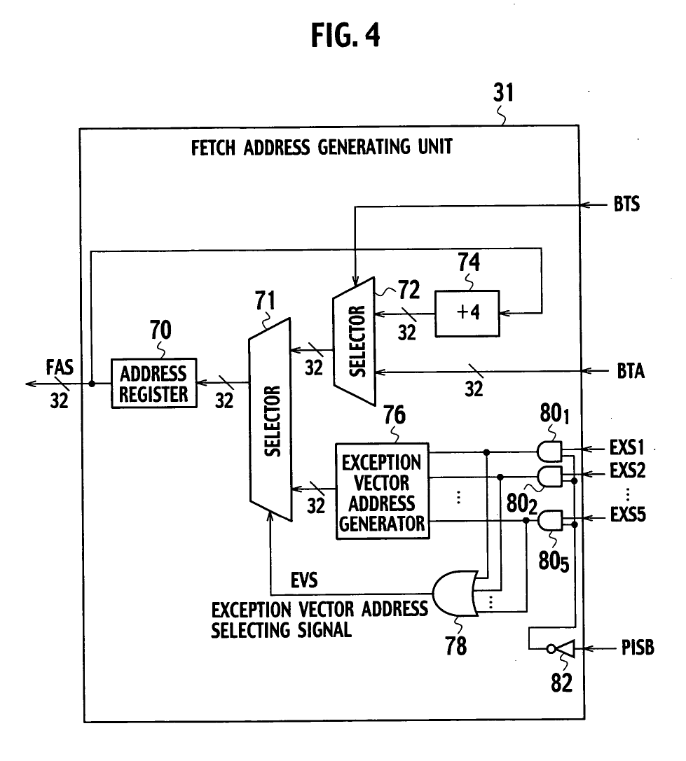

Next, processing for a debug exception when executing a protected instruction is described while referencing FIG. 4.

FIG. 4 schematically shows a block diagram of major components in a fetch address generating unit 31 of the instruction fetch unit 30.

As shown in FIG. 4, the fetch address generating unit 31 in the instruction fetch unit 30 is constituted by an inverter 82, which inverts the protection information signal PISB, AND gates 80₁, 80₂, . . . , 80₅, each receiving an output signal of the inverter 82 at one of the input terminals and exception signals EXS1, EXS2, . . . , EXS5 at the other input terminal, an exception vector address generator 76, which receives output signals of the respective AND gates 80₁, 80₂, . . . 80₅, an OR gate 78, which receives the output signals from the respective AND gates 80₁, 80₂, . . . , 80₅, and outputs an exception vector address selecting signal EVS, an adder 74, which receives a fetch address FAS, a selector 72, which receives an output signal of the adder 74, a branch address BTA, and a branching condition satisfaction determining signal BTS, a selector 71, which receives an output signal of the selector 72, an output signal of the exception vector address generator 76, and the exception vector address selecting signal EVS, and an address register (PC) 70, which receives an output signal of the select circuit 71 and outputs the fetch address FAS.

When a debug exception occurs and the processor core module 100 receives the exception signals EXS1, EXS2, . . . , EXS5, data indicating exception occurrence status is stored in the specific address register 70 in accordance with the respective debug exceptions. Afterward, branching to a program starting at the exception vector address designated by the exception vector address generator 76 occurs.

A debugging program is activated by each program. The processor core module 100 inputs/outputs debugging program data to/from the external debugger 12 via the debug module 120, performing a debugging operation. In this case, debug exceptions used for implementing the debugging function are as follows:

(a) Single Step

When a single step bit in the debugging register is set to data ‘1’, a debug exception occurs for every instruction execution. When a debug exception occurs, a current program counter value for an instruction being executed is stored in a debugging program counter register.

(b) Instruction Address Break

When the value of an instruction break address register agrees with the current program counter value of an instruction being executed, a debug exception occurs.

(c) Data Address and Value Break

When the value of a data break address register agrees with a data address value of a load/store instruction, a debug exception occurs.

(d) Debugging Break Instruction

When a debugging break instruction is executed, a debug exception occurs.

(e) Debugging Interrupt

When a debugging interrupt signal is asserted from the outside the processor, a debug exception occurs.

As shown in FIG. 4, when the fetch address generating unit 31 in the instruction fetch unit 30 of the execution unit 400, which generates a subsequent instruction address to be executed, receives an exception signal with the highest priority, an exception vector address corresponding to that signal is output from the exception vector address generator 76, written in the address register (PC) 70, and output as the fetch address FAS. However, during protected instruction execution, the protection information signal PISB is ‘1’. Each of exception signals EXS1, EXS2, . . . , EXS5 is set to ‘0’ irrespective of the values output from respective exception signal generators, and exception vector address generation and address selection are not carried out.

In addition, the outputs of the exception signals EXS1, EXS2, . . . , EXS5 controlled by the protection information signal PISB are also input to various data storage/processing circuits when an exception occurs in the processor core module 100. This prohibits a debug exception from occurring.

The processor core module having a program protection function according to the embodiment of the present invention, provides a high-performance program protection function to prevent trace information from being output and prohibits occurrence of a debug exception when executing an instruction in a protected program. Thereby, the processor core module makes indirect generation of program code information difficult.

The processor of the embodiments of the present invention maintains development efficiency of a user program (unprotected program) being developed by generating and displaying trace information to facilitate debugging on an actual system device. Also, generation of trace information indicating execution logs of a protected program is prohibited so as to prevent the protected program from being subjected to algorithm analysis using information such as program loop statuses and loop counts, thereby improving the protection level.

The processor of the present invention minimizes the amount of trace information. Further, a trace information generating system configured to output instruction types and branch destination addresses, without instruction execution addresses, is used so as to compress trace information. When such system operates based on a mixture of an unprotected program and a protected program, a branch address for branching from the protected program to the unprotected program may be obtained. This increases reliability of trace information analysis of the unprotected program.

The processor of the embodiments of the present invention maintains development efficiency of a user program (unprotected program) being developed by generating a debug exception for displaying various pieces of processor information at a specified time to facilitate debugging, and a debug exception is prohibited for a protected program so as to prevent disclosure of changes in processor register values for every single step operation, resulting in prevention of disclosure of instruction types in the protected program. This allows improvement in protection level.

### Other Embodiments

While the present invention is described in accordance with the aforementioned embodiments, it should not be understood that the description and drawings that configure part of this disclosure are to limit the present invention. This disclosure makes clear a variety of alternative embodiments, working examples, and operational techniques for those skilled in the art. Accordingly, the technical scope of the present invention is defined by only the claims that appear appropriate from the above explanation.

Various modifications will become possible for those skilled in the art after receiving the teachings of the present disclosure without departing from the scope thereof.

What is claimed is:

1. A processor having a program protection function, which protects a program by allowing only reading out of an instruction as a decrypted, protected plain text program for being executed, the processor comprising:
a protected program instruction execution detecting unit configured to detect whether an instruction in a protected program is being executed; and
a trace information generating unit configured to prohibit generation of trace information for an instruction being executed when detecting that an instruction in a protected program is being executed.

2. The processor having a program protection function of claim 1, wherein,
the trace information generating unit generates trace information, which indicates that no instructions are executed, instead of trace information for an actually executed instruction when detecting that an instruction in a protected program is being executed.

3. The processor having a program protection function of claim 1, wherein,
the trace information generating unit is configured to generate trace information, which indicates that a branch instruction is executed, and a branch destination address when a branch instruction is being executed, a branch condition is satisfied, and a branch destination address is in an unprotected area during protected program execution.

4. The processor having a program protection function of claim 1, wherein,
the protected program instruction execution detecting unit comprises a protection bit signal storage unit configured to be stored with a protection bit that corresponds to a region of program memory constituted by one region or more than one region into which at least a protected plain text program is loaded and that indicates whether or not a program in the region is being protected,
and is configured to read out an instruction from an address in the program memory designated by a program counter and read out the protection bit from a region including the address designated by the program counter, thereby detecting whether an instruction in a protected program is being executed before the instruction is executed.

5. The processor having a program protection function of claim 2, wherein,
the trace information generating unit is configured to generate trace information, which indicates that a branch instruction is executed, and a branch destination address when a branch instruction is being executed, a branch condition is satisfied, and a branch destination address is in an unprotected area during protected program execution.

6. The processor having a program protection function of claim 3, wherein,
a branch destination address to be output during protected program execution is controlled so as to output all of address information when branching to an unprotected area in conformity to a protected branch instruction occurs.

7. The processor having a program protection function of claim 5, wherein,
a branch destination address to be output during protected program execution is controlled so as to output all of address information when branching to an unprotected area in conformity to a protected branch instruction occurs.

8. A processor having a program protection function, which protects a program by allowing reading out of only an instruction in a protected program decrypted to plain text for being executed the instruction, the processor comprising:
a protected program instruction execution detecting unit configured to detect whether an instruction in a protected program is being executed; and
a debug exception occurrence prohibiting unit configured to prohibit occurrence of a debug exception when the protected program instruction execution detecting unit detects that an instruction in a protected program is being executed.

9. The processor having a program protection function of claim 8, wherein,
the protected program instruction execution detecting unit comprises a protection bit signal storage unit configured to be stored with a protection bit that corresponds to a region of program memory constituted by one region or more than one region into which at least a protected plain text program is loaded and that indicates whether a program in the region is being protected,
and is configured to read out an instruction from an address in the program memory designated by a program counter and read out the protection bit from a region including the address designated by the program counter, thereby detecting whether an instruction in a protected program is being executed before the instruction is executed.

10. A processor having a program protection function, which protects a program by allowing reading out of only an instruction in a protected program decrypted to plain text for execution and executing an instruction read out from program memory, the processor comprising:
a protection bit signal storage unit configured to store a protection bit which indicates whether a part of the program memory is being protected;
a program counter configured to designate an instruction execution address; and
a trace information generating unit configured to read out an instruction from an address of the program memory designated by the program counter, and detect whether the corresponding region is being protected, and when the corresponding region is being protected, outputs a code, which indicates that no instructions are executed as trace information, and prohibits generation of trace information of an instruction being executed.

11. The processor having a program protection function of claim 10, wherein
the trace information generating unit outputs as program trace information a code, which indicates that a branch instruction is executed, and a branch destination address when a branch instruction is read out, and a branch destination address is in an unprotected area.

12. The processor having a program protection function of claim 10, wherein
the trace information generating unit generates trace information, which indicates that no instructions are executed, instead of trace information of an actually executed instruction when detecting that an instruction in a protected program is being executed.

13. The processor having a program protection function of claim 10, wherein
the protection bit signal storage unit configured to be stored with a protection bit that corresponds to a region of program memory constituted by one region or more than one region into which at least a protected plain text program is loaded and that indicates whether or not a program in the region is being protected, and
the trace information generating unit reads out an instruction from an address of the program memory designated by a program counter, and reads out a protection bit from a region including the address designated by the program counter, thereby detecting whether an instruction in a protected program is being executed.

14. The processor having a program protection function of claim 10, further comprising:
a debug exception generation prohibiting unit configured to read out an instruction from an address of the program memory designated by the program counter, detect whether the corresponding region is being protected, and when the corresponding region is being protected, prohibit occurrence of a debug exception.

15. The processor having a program protection function of claim 12, further comprising:
a trace information generating unit configured to generate trace information, which indicates that a branch instruction is executed, and a branch destination address when a branch instruction is being executed, a branch condition is satisfied, and a branch destination address is in an unprotected area during protected program execution.

16. The processor having a program protection function of claim 15, wherein
a branch destination address to be output during protected program execution is controlled so as to output all of address information when branching to an unprotected area in conformity to a protected branch instruction occurs.
